(19) United States
(12) Patent Application Publication
(10) Pub. No.: US 2025/0214852 A1
(43) Pub. Date: Jul. 3, 2025

(54) MWW Zeolite Precursor Nanoparticles Having an Uncondensed Layer Structure and Methods for Production Thereof

(71) Applicant: ExxonMobil Chemical Patents Inc., Baytown, TX (US)

(72) Inventors: Takayuki Iida, Iselin, NJ (US); Aaron W. Peters, New Hope, PA (US)

(21) Appl. No.: 18/848,798

(22) PCT Filed: Mar. 14, 2023
(86) PCT No.: PCT/US2023/064315

§ 371 Date: Sep. 19, 2024

Related U.S. Application Data
(60) Provisional application No. 63/327,417, filed on Apr. 5, 2022.

(51) Int. Cl. C01B 39/48; B01J 21/04; B01J 29/70; B01J 35/23; B01J 35/45

(52) U.S. Cl. CPC C01B 39/48; B01J 21/04; B01J 29/7038; B01J 35/23; B01J 35/45; C01P 2004/64

(57) ABSTRACT

Zeolite precursor nanoparticles may be formed by contacting a parent zeolite precursor, such as MCM-22 zeolite precursor, MCM-56 zeolite precursor, or EMM-10 zeolite precursor, with an aqueous base under temperature conditions at which adjacent stacked layers in the MWW zeolite framework do not undergo substantial condensation with one another. The zeolite precursor nanoparticles may be converted to zeolite nanoparticles following calcination. The zeolite nanoparticles may optionally be formed into an extrudate using a binder. Unbound or extrudate forms of the zeolite nanoparticles may be utilized to promote alkylation of C6+ aromatic compounds.

### CROSS-REFERENCE TO RELATED APPLICATION

This application claims priority to and the benefit of U.S. Provisional Application No. 63/327,417 having a filing date of Apr. 5, 2022, the disclosure of which is incorporated herein by reference in its entirety.

### FIELD

The present disclosure relates to zeolites and catalytic processes employing the same.

### BACKGROUND

Zeolites are a diverse class of crystalline microporous inorganic framework materials, which are widely used as molecular sieves, ion exchangers, and solid acid catalysts. Various zeolite framework structures recognized by the Structure Commission of the International Zeolite Association are maintained in a structural database accessible at http://www.iza-structure.org/databases/. The inorganic framework (framework structure) defining a particular zeolite is characterized by a plurality of pores or channels of specified size that are present therein. The pore or channel size varies for different zeolites and, in turn, determines the breadth of molecules that may reach the interior of a particular zeolite. By virtue of their defined-size porosity, zeolites may find utility as selective sorbents and promote catalytic reactions for various types of molecules having a size compatible to enter a given zeolite by way of the pores or channels.

Due to their crystalline nature, powder X-ray diffraction (XRD) may be utilized to characterize the structure of zeolites. Natural and synthetic zeolites may feature a rigid three-dimensional framework of SiO₄ tetrahedra, in which adjacent tetrahedra share oxygen atoms and a portion of the Si atoms may be optionally replaced with other atoms. For example, at least some tetrahedra in a given zeolite may contain alternative atoms in place of silicon such as, for example, boron, gallium, aluminum, iron, titanium, zinc, vanadium, and the like. Electrical neutrality may be maintained in tetrahedra not containing a tetravalent element through inclusion of a cation, such as a hydrogen ion, an alkali metal cation, or an alkaline earth metal cation, which is not part of the tetrahedral structure and is instead associated therewith through electrostatic charge pairing.

Zeolites having an MWW framework (MWW zeolites) are but one type of zeolite structure that have been explored extensively for use in catalytic reactions. MWW zeolites include a range of framework structures including fully condensed, ordered layer structures (MCM-49), uncondensed, ordered layer structures (MCM-22), and disordered single- or multi-layer structures (MCM-56 and EMM-10). Other pes of MWW zeolites are known as well, such as ITQ-1, ITQ-2, UZM-8, and UZM-8HS. A structure directing agent (SDA) may be used to promote formation of precursor to a given MWW zeolite framework structure. The SDA may be removed during calcination to leave empty pore space within the zeolite framework structure. If care is not taken, the various MWW zeolite precursors may interconvert with one another, thereby affording a mixture of zeolites following calcination. The fully condensed layer structure of MCM-49 may form in some cases.

FIG. 1 is a diagram showing characteristic powder X-ray diffraction data (XRD) for various types of MWW zeolite precursors and a pictorial representation of the types of layer structures present therein. Peaks marked with an asterisk in FIG. 1 are characteristic peaks from the fully condensed, ordered layer structure of MCM-49, and ingrowth and/or sharpening of these XRD peaks in samples of other zeolite precursors may be diagnostic of interconversion of an initially uncondensed layer structure into an at least partially condensed layer structure form. XRD peaks located at 2θ˜6.5° (box A in FIG. 1) are characteristic of the interlayer distance. Since MCM-49 is fully condensed and MCM-56 has a disordered stacking structure, neither of which affords an interlayer distance, these zeolites lack a peak at this position. XRD peaks located at 2θ˜8°-10° (box B in FIG. 1) are characteristic of the 101 and 102 crystallographic peaks, and the degree of stacking disorder is embodied in this region. MCM-49 and MCM-22 have ordered structures and exhibit sharp peaks in this region, whereas MCM-56 and EMM-10 are disordered and exhibit broadened peaks as a consequence of their structure. Additional characterization of the XRD patterns of MWW zeolites may be found in U.S. Pat. Nos. 5,236,575 and 4,954,325, each of which is incorporated herein by reference.

Nanoparticle forms of zeolites may be desirable in many instances due to their potential to enhance catalytic activity and selectivity, increase substrate accessibility, and improve product desorption kinetics. Unfortunately, direct syntheses of zeolite nanoparticles may be challenging, and conversion of as-produced zeolites or zeolite precursors into a nanoparticle form may be challenging as well. In the case of MWW zeolites, specific polymer additives or multiple structure directing agents (SDAs) and/or multi-step syntheses may be needed for directly synthesizing MWW zeolite precursors in nanoparticle form, followed by calcination to form the corresponding MWW zeolite nanoparticles. Another approach for producing MWW zeolite nanoparticles involves heating an aqueous base with a MWW zeolite precursor at a temperature of about 70° C. or above, preferably about 80° C. The aqueous base treatment promotes fragmentation of as-produced zeolite precursor crystals into a nanoparticle size range, with MWW zeolite nanoparticles again resulting following calcination. Unfortunately, the high reaction temperatures at which zeolite precursor crystal fragmentation takes place may be problematic with respect to scalability and yield reductions resulting from silicon loss. In addition, at least partial conversion of uncondensed MWW zeolite precursors into a fully condensed layer structure, such as that found in MCM-49, may occur at the reaction temperature conventionally used to produce zeolite precursor nanoparticles from a parent zeolite.

### SUMMARY

In some aspects, the present disclosure provides compositions comprising: a plurality of zeolite precursor nanoparticles formed from a parent zeolite precursor having an MWW framework and comprising a plurality of stacked layers; wherein the zeolite precursor nanoparticles are about 200 nm or less in size, and adjacent stacked layers in the MWW framework remain substantially uncondensed with one another in the zeolite precursor nanoparticles; and wherein the zeolite precursor nanoparticles contain at most one structure directing agent (SDA).

In some aspects, the present disclosure provides methods for making MWW zeolite nanoparticles, comprising: providing a parent zeolite precursor having an MWW framework comprising a plurality of stacked layers; and contacting the parent zeolite precursor with an aqueous base under temperature conditions sufficient to fragment the parent zeolite precursor into a plurality of zeolite precursor nanoparticles that are about 200 nm or less in size and maintain the MWW framework substantially without inducing condensation between adjacent stacked layers in the MWW framework.

In still other aspects, the present disclosure provides aromatic alkylation methods, comprising: providing an aromatic feed mixture comprising one or more C6+ aromatic hydrocarbons; providing an extrudate comprising a composition of the present disclosure in a calcined form, the calcined form comprising zeolite nanoparticles lacking the structure directing agent; contacting the aromatic feed mixture with the extrudate under alkylation conditions in the presence of an alkylation agent; and obtaining a product stream comprising one or more alkylated C6+ aromatic hydrocarbons after contacting the aromatic feed mixture with the composition under the alkylation conditions.

These and other features and attributes of the disclosed methods and compositions of the present disclosure and their advantageous applications and/or uses will be apparent from the detailed description which follows.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one having ordinary skill in the art and having the benefit of this disclosure.

To assist one of ordinary skill in the relevant art in making and using the subject matter hereof, reference is made to the appended drawings, wherein:

FIG. 1 is a diagram showing characteristic powder X-ray diffraction data for various types of MWW zeolite precursors and a pictorial representation of the types of layer structures present therein.

FIG. 2 shows a diagram of overlaid powder X-ray diffraction patterns for MCM-22 zeolite precursor nanoparticles produced according to Example 1 under various conditions.

FIGS. 3A-3C show SEM images of MCM-22 zeolite precursor nanoparticles produced according to Example 1 under various conditions. FIG. 3D shows an SEM image of parent MCM-22 zeolite precursor.

FIG. 4 shows a diagram of overlaid powder X-ray diffraction patterns for EMM-10 zeolite precursor nanoparticles produced according to Example 2 under various conditions.

FIGS. 5A and 5B show SEM images of EMM-10 zeolite precursor nanoparticles produced according to Example 2 under various conditions. FIG. 5C shows an SEM image of parent EMM-10 zeolite precursor.

FIG. 6 is a plot of the ratio [DIPB]/[IPB] versus the kinetic parameter of cumene alkylation (Rate-Constant) using MCM-22 zeolite nanoparticles.

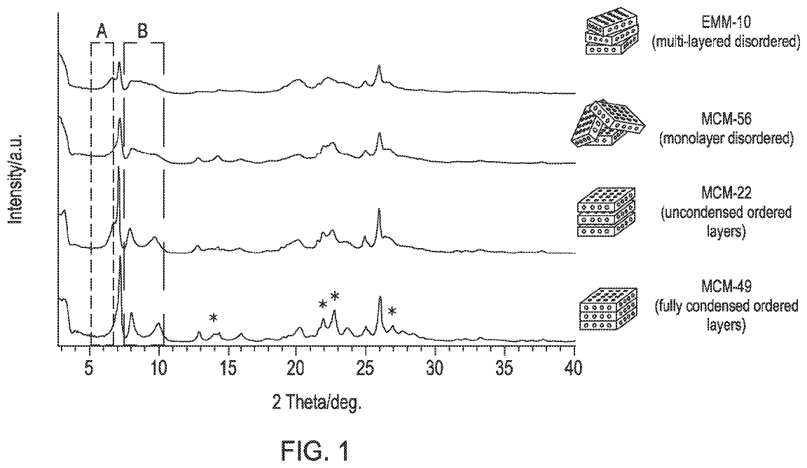

### DETAILED DESCRIPTION

The present disclosure relates to zeolites and, more particularly, zeolite nanoparticles, precursors thereof, and catalytic reactions performed therewith.

### Definitions

Various specific embodiments, versions and examples of the invention will now be described, including preferred embodiments and definitions that are adopted herein for purposes of understanding the claimed invention. While the following detailed description gives specific preferred embodiments, those skilled in the art will appreciate that these embodiments are exemplary only, and that the invention may be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

In this disclosure, a process may be described as comprising at least one “step.” It should be understood that each step is an action or operation that may be carried out once or multiple times in the process, in a continuous or discontinuous fashion. Unless specified to the contrary or the context clearly indicates otherwise, multiple steps in a process may be conducted sequentially in the order as they are listed, with or without overlapping with one or more other step, or in any other order, as the case may be. In addition, one or more or even all steps may be conducted simultaneously with regard to the same or different batch of material. For example, in a continuous process, while a first step in a process is being conducted with respect to a raw material just fed into the beginning of the process, a second step may be carried out simultaneously with respect to an intermediate material resulting from treating the raw materials fed into the process at an earlier time in the first step. Preferably, the steps are conducted in the order described.

Unless otherwise indicated, all numbers indicating quantities in this disclosure are to be understood as being modified by the term “about” in all instances. It should also be understood that the precise numerical values used in the specification and claims constitute specific embodiments. Efforts have been made to ensure the accuracy of the data in the examples. However, it should be understood that any measured data inherently contain a certain level of error due to the limitation of the technique and equipment used for making the measurement.

As used herein, the indefinite articles “a” or “an” shall mean “at least one” unless specified to the contrary or the context clearly indicates otherwise. Thus, for example, embodiments using “a fractionation column” include embodiments where one, two or more fractionation columns are used, unless specified to the contrary or the context clearly indicates that only one fractionation column is used.

As used herein, the term “consisting essentially of” means a composition, feed, stream or effluent that includes a given component or group of components at a concentration of at least about 60 wt %, preferably at least about 70 wt %, more preferably at least about 80 wt %, more preferably at least about 90 wt %, or still more preferably at least about 95 wt %, based on the total weight of the composition, feed, stream or effluent.

The following abbreviations may be used herein for the sake of brevity: RT is room temperature (and is 23° C. unless otherwise indicated), kPag is kilopascal gauge, psig is pound-force per square inch gauge, psia is pounds-force per square inch absolute, and WHSV is weight hourly space velocity.

As used herein, “wt %” means percentage by weight, “vol %” means percentage by volume, “mol %” means percentage by mole, “ppm” means parts per million, and “ppm wt” and “wppm” are used interchangeably to mean parts per million on a weight basis. All concentrations herein are expressed on the basis of the total amount of the composition in question. All ranges expressed herein should include both end points as two specific embodiments unless specified or indicated to the contrary.

Nomenclature of elements and groups thereof used herein are pursuant to the Periodic Table used by the International Union of Pure and Applied Chemistry after 1988. An example of the Periodic Table is shown in the inner page of the front cover of Advanced Inorganic Chemistry, 6^{th} Edition, by F. Albert Cotton et al. (John Wiley & Sons. Inc., 1999).

As used herein, the term “hydrocarbon” means (i) any compound consisting of hydrogen and carbon atoms or (ii) any mixture of two or more such compounds in (i). The term “Cn hydrocarbon,” where n is a positive integer, means (i) any hydrocarbon compound comprising carbon atom(s) in its molecule at the total number of n, or (ii) any mixture of two or more such hydrocarbon compounds in (i). Thus, a C2 hydrocarbon can be ethane, ethylene, acetylene, or mixtures of at least two of such at any proportion. A “Cm to Cn hydrocarbon” or “Cm-Cn hydrocarbon.” where m and n are positive integers and m<n, means any of Cm, Cm−1. Cm+2, . . . , Cn−1, Cn hydrocarbons, or any mixtures of two or more thereof. Thus, a “C2 to C3 hydrocarbon” or “C2-C3 hydrocarbon” can be any of ethane, ethylene, acetylene, propane, propene, propyne, propadiene, cyclopropane, and any mixtures of two or more thereof at any proportion between and among the components. A “saturated C2-C3 hydrocarbon” can be ethane, propane, cyclopropane, or any mixture thereof of two or more thereof at any proportion. A “Cn+ hydrocarbon” means (i) any hydrocarbon compound comprising carbon atom(s) in its molecule at the total number of at least n, or (ii) any mixture of two or more such hydrocarbon compounds in (i). A “Cn− hydrocarbon” means (i) any hydrocarbon compound comprising carbon atoms m its molecule at the total number of at most n, or (ii) any mixture of two or more such hydrocarbon compounds in (i). A “Cm hydrocarbon stream” means a hydrocarbon stream consisting essentially of Cm hydrocarbon(s). A “Cm-Cn hydrocarbon stream” means a hydrocarbon stream consisting essentially of Cm-Cn hydrocarbon(s).

As used herein, an “aromatic hydrocarbon” is a hydrocarbon comprising an aromatic ring in the molecular structure thereof. An aromatic compound may have a cyclic cloud of pi electrons meeting the Hackel rule. A “non-aromatic hydrocarbon” means a hydrocarbon other than an aromatic hydrocarbon.

As used herein, the term “lower aromatic hydrocarbons” refers to benzene, toluene, or a mixture of benzene and toluene.

The term “selectivity” refers to the degree to which a particular reaction forms a specific product, rather than another product.

As used herein, the term “liquid-phase” means reaction conditions in which aromatic hydrocarbons present in a reactor are substantially in a liquid state. “Substantially in liquid phase” means≥about 90 wt %, preferably≥about 95 wt %, preferably≥about 99 wt %, and preferably the entirety of the aromatic hydrocarbons, is in liquid phase.

As used herein, the term “vapor-phase” means reaction conditions in which aromatic hydrocarbons present in a reactor are substantially in a vapor state. “Substantially in vapor phase” means≥about 90 wt %, preferably≥about 95 wt %, preferably≥about 99 wt %, and preferably the entirety of the aromatic hydrocarbons, is in vapor phase.

As used herein, the term “alkylation” means a chemical reaction in which an alkyl group is transferred from an alkyl group source compound (alkylation agent), optionally with rearrangement occurring in the process of being transferred, to an aromatic ring as a substitute group for a hydrogen atom thereon. One or more alkyl groups may be transferred during an alkylation reaction.

As used herein, the term “alkylated aromatic hydrocarbon” means an aromatic hydrocarbon comprising at least one alkyl group attached to an aromatic ring thereof. An alkyl group reacting with an aromatic hydrocarbon may be straight-chain or branched.

### Zeolite Nanoparticles and Synthesis Thereof

As discussed above, zeolite nanoparticles may be a desirable form for zeolite materials due to their potential to enhance catalytic activity and selectivity, increase substrate accessibility, and improve product desorption kinetics. However, direct syntheses of zeolite nanoparticles and conversion of zeolite precursors into zeolite nanoparticles may both be challenging. For example, to produce MWW zeolites in nanoparticle form via direct syntheses, specific polymer additives or multiple structure directing agents and/or multi-step syntheses may be needed to produce MWW zeolite precursors in nanoparticle form, followed by calcination to form MWW zeolite nanoparticles. Base-induced fragmentation of MWW zeolite precursors at elevated temperatures (above about 70° C.) may be conducted as an alternative but may problematic in terms of scalability, yield reduction, and crystallographic changes occurring at the elevated reaction temperatures.

The present disclosure provides the surprising result that MWW zeolite precursor nanoparticles may be formed at temperatures lower than those conventionally believed to be suitable for promoting base-induced fragmentation of MWW zeolite precursors (i.e., about 70° C. or above). Namely, in the present disclosure, reaction temperatures from about 60° C. to as low as room temperature were found to promote effective formation of MWW zeolite precursor nanoparticles, which may then be converted to the corresponding MWW zeolite following calcination. Formation of MWW zeolite nanoparticles through base-induced fragmentation of a MWW zeolite precursor is considered advantageous since such processes allow non-nanoparticle, commercial MWW zeolite precursors to be used as a convenient source material, rather than having to resort to multiple, specialized SDAs and/or multi-step zeolite syntheses. In addition, the lower-temperature base-induced fragmentation conditions disclosed herein also tend to promote less yield loss than that occurring at higher reaction temperatures and may be more convenient to implement in large-scale production.

A further surprising and potentially advantageous benefit of the present disclosure is that the lower-temperature base-induced fragmentation conditions may afford MWW zeolites having a lower amount of (or no) undesired crystallographic phases. At the elevated-temperature base-induced conditions conventionally used for fragmenting MWW zeolite precursors (above about 70° C.), at least partial conversion of MWW zeolite precursors having an uncondensed layer structure (e.g., MCM-22. MCM-56, and EMM-10) into a condensed layer structure analogous to that of MCM-49 may occur. At the lower-temperature base-induced fragmentation conditions disclosed herein, formation of condensed zeolite phases as contaminants may be significantly suppressed or eliminated when forming MWW zeolite precursor nanoparticles. By mitigating the formation of additional crystallographic phases during MWW zeolite precursor fragmentation, more pristine MWW zeolites of a given type may be obtained upon calcination. Moreover, by producing more pristine MWW zeolite nanoparticles of a given type, improved catalytic activity and/or a decreased propensity toward unwanted catalytic side reactions promoted by the additional crystallographic phase(s) may be realized.

The zeolite nanoparticles disclosed herein may be readily extruded into various forms, either as self-bound extrudates or with a suitable binder. The amount of the zeolite nanoparticles within the extrudates may be adjusted to target a particular ratio of products in a catalytic process. Moreover, the catalytic activity of the zeolite nanoparticles within the extrudates may be higher than that obtained when unbound zeolite nanoparticles are employed in a similar catalytic reaction.

Accordingly, methods for making zeolite precursor nanoparticles may comprise: providing a parent zeolite precursor having an MWW framework comprising a plurality of stacked layers; and contacting the parent zeolite precursor with an aqueous base under temperature conditions sufficient to fragment the parent zeolite precursor into a plurality of zeolite precursor nanoparticles that are about 200 nm or less in size and maintain the MWW framework substantially without inducing condensation between adjacent stacked layers in the MWW framework. Suitable temperature conditions are specified further below. A determination of whether condensation between adjacent stacked layers has occurred may utilize an appropriate crystallographic technique, particularly powder X-ray diffraction (XRD). Ingrowth of XRD peaks characteristic of a fully condensed layer structure may be diagnostic of condensation occurring between adjacent stacked layers. No significant condensation between adjacent stacked layers is considered to occur in the disclosure herein if a change in powder XRD pattern does not occur following base-promoted fragmentation.

Zeolite precursor nanoparticles produced according to the disclosure herein may be distinguished from those obtained by alternative production methods in several ways. In one example, the zeolite precursor nanoparticles may be distinguished by their substantial lack of a fully condensed phase, similar to that of MCM-49, as referenced above. In another example, the zeolite precursor nanoparticles may be distinguished by containing at most one SDA, thereby providing distinction over zeolite precursor nanoparticles produced by alternative methods employing multiple small-molecule SDAs and/or a polymer-based SDA in combination with a small-molecule SDA.

Thus, compositions obtained by the zeolite nanoparticle precursor syntheses described herein may comprise a plurality of zeolite precursor nanoparticles formed from a parent zeolite precursor having an MWW framework and comprising a plurality of stacked layers, in which the zeolite precursor nanoparticles are about 200 nm or less in size, adjacent stacked layers in the MWW framework remain substantially uncondensed with one another in the zeolite precursor nanoparticles, and the zeolite precursor nanoparticles contain at most one SDA. The identity of the SDA within the zeolite precursor nanoparticles (if present at all) produced according to the disclosure herein is not considered to be particularly limited.

In non-limiting examples, the zeolite precursor nanoparticles may range from about 50 nm to about 300 nm in size, or about 50 nm to about 250 nm in size, or about 100 nm to about 200 nm in size, or about 100 nm to about 150 nm in size, or about 150 nm to about 200 nm in size, or about 150 nm to about 250 nm in size. Particle sizes are absolute ranges determined from scanning electron microscopy or a similar imaging technique.

Suitable MWW zeolite precursors that may undergo base-promoted fragmentation according to the disclosure herein include, but are not limited to, precursors forming (after appropriate calcination) MCM-22, MCM-56, EMM-10, or any combination thereof. Other suitable MWW zeolite precursors may include ITQ-1. UZM-8, and the like. The MWW zeolite precursors may optionally contain a SDA that is retained from the parent zeolite precursor synthesis, wherein the structure of the SDA is not believed to be particularly limited. The SDA may continue to be retained or may be lost upon formation of the zeolite precursor nanoparticles according to the disclosure herein. If still present after forming zeolite precursor nanoparticles, the SDA may be removed during calcination (discussed below) to convert the zeolite precursor nanoparticles into zeolite nanoparticles.

After formation thereof, the plurality of zeolite precursor nanoparticles may be grouped together as a plurality of agglomerates. The agglomerates may range from about 150 nm to about 2000 nm in size, or about 200 nm to about 1000 nm in size, or about 100 nm to about 800 nm in size, or about 500 to about 1500 nm in size.

In non-limiting examples, contacting the parent zeolite precursor with the aqueous base may comprise stirring the parent zeolite precursor with the aqueous base. Stirring rates and contact times are not believed to be especially limited. Static contact between the parent zeolite precursor and the aqueous base may also be sufficient to produce zeolite precursor nanoparticles in some instances.

The aqueous base may comprise an alkali metal hydroxide dissolved in water or other suitable aqueous solvent. Suitable alkali metal hydroxides may include, for example, lithium hydroxide, sodium hydroxide, potassium hydroxide, rubidium hydroxide, cesium hydroxide, or any combination thereof. Preferably, the alkali metal hydroxide may comprise lithium hydroxide, sodium hydroxide, potassium hydroxide, or any combination thereof. Other suitable aqueous bases may include, for example, alkali metal carbonates, tetraalkylammonium hydroxides, or the like.

Suitable base concentrations within the aqueous base may include any concentration within the water or aqueous solvent that is sufficient to convert the parent zeolite precursor into zeolite precursor nanoparticles without inducing substantial condensation between adjacent stacked layers. Suitable base concentrations may range up to the solubility limit of the base but are preferably lower. In non-limiting examples, suitable base concentrations within the aqueous base may be about 1.5 M or lower, or about 1.0 M or lower, or about 0.75 M or lower, or about 0.5 M or lower, such as a base concentration ranging from about 0.2 M to about 1.2 M, or about 0.25 M to about 1.0 M, or about 0.3 M to about 0.7 M, or about 0.4 M to about 0.8 M, or about 0.2 M to about 0.5 M.

Temperature conditions suitable for forming zeolite precursor nanoparticles in the disclosure herein may include any temperature above the freezing point of the aqueous base and a temperature at which condensation of adjacent stacked layers begins to occur. In some embodiments, the temperature conditions may comprise a temperature of about 60° C. or below, or about 50° C. or below, or about 40° C. or below, or about 30° C. or below, or even room temperature or below. Thus, suitable temperature conditions may range from the freezing point of the aqueous base up to about room temperature, or up to about 30° C., or up to about 40° C., or up to about 50° C., or up to about 60° C. In another example, suitable temperature conditions may range from about room temperature up to about 40° C., or up to about 50° C., or up to about 60° C. It is to be appreciated that suitable temperature conditions may depend upon the actual MWW zeolite precursor undergoing fragmentation, the aqueous base concentration, and the contacting time, among other parameters.

Zeolite precursor nanoparticles produced in accordance with the disclosure above may be converted into the corresponding zeolite nanoparticles by calcining in air, optionally after or before conversion to hydrogen-form by, e.g., ammonium exchange. Accordingly, methods of the present disclosure may further comprise calcining the plurality of zeolite precursor nanoparticles in air to form a plurality of zeolite nanoparticles. Suitable calcination conditions may at least remove a SDA (if present) or residual organic compounds by thermal degradation and convert other elements into their corresponding oxide form, which are retained in the zeolite nanoparticles. In non-limiting examples, suitable calcination temperatures may range from about 500° C. to about 1000° C., or about 550° C. to about 750° C., or about 500° C. to about 650° C. Following calcination, the resulting zeolite nanoparticles may be obtained in a similar size range as the zeolite precursor nanoparticles from which they were produced.

Methods of the present disclosure may further comprise forming shaped catalysts such as pellets, extrudates, powder, and the like, which comprises the zeolite nanoparticles prepared as described above. The shaped catalysts can be self-bound and thus essentially free of a binder. The shaped catalysts can comprise a suitable binder. Thus, zeolite precursor nanoparticles, or zeolite precursor nanoparticles, or mixtures thereof without a binder, or mixture of either or both with a suitable binder, can be processed to form the shaped catalysts by using various methods known in the art, e.g., by extrusion, casting, and the like, optionally followed by ammonium exchange, optionally followed by drying, and optionally followed by calcination.

Suitable binders that may be present in the extrudates are not considered to be especially limited. In non-limiting examples, suitable binders may include, for instance, clays, alumina, silica, silica-alumina, silica-magnesia, silica-zirconia, silica-thoria, silica-beryllia, and silica-titania, as well as ternary compositions, such as silica-alumina-thoria, silica-alumina-zirconia, silica-alumina-magnesia and silica-magnesia-zirconia. The relative proportions of zeolite and binder may range from about 1:99 to about 99:1 on a mass basis. In illustrative examples, the zeolite nanoparticles (or zeolite precursor nanoparticles) may be present in an amount of 10% to about 70% by mass of the extrudates, or about 20% to about 50% by mass of the extrudates.

Both extrudate forms and free powder (unbound) forms of zeolite nanoparticles produced in accordance with the disclosure above may be utilized in various catalytic processes. Catalytic processes in which the zeolite nanoparticles may be used include any catalytic process in which conventional (non-nanoparticle) MWW zeolites may be used. Illustrative examples of suitable catalytic processes in which MWW zeolites may be used follows.

Aromatic alkylation processes with olefins that are normally liquids at room temperature may be promoted by the MWW zeolite nanoparticles. Aromatic compounds that may be alkylated include lower aromatic hydrocarbons, such as benzene and/or toluene, although other aromatic hydrocarbons may be suitably alkylated as well. Illustrative reaction conditions may include a temperature ranging from about 340° C. to about 500° C. a pressure ranging from about atmospheric pressure to about 200 atmospheres, a weight hourly space velocity (WHSV) ranging from about 2 hr⁻¹ to about 2000 hr⁻¹, and an aromatic hydrocarbon/olefin mole ratio ranging from about 1:1 to about 20:1.

Aromatic alkylation processes with olefins that are normally gases at room temperature may be promoted by the MWW zeolite nanoparticles. Aromatic compounds that may be alkylated include lower aromatic hydrocarbons, such as benzene and/or toluene, although other aromatic hydrocarbons may be suitably alkylated as well. Illustrative reaction conditions may include a temperature ranging from about 10° C. to about 240° C., or about 20° C. to about 220° C., or about 40° C. to 200° C., or about 50° C. to about 150° C., a pressure ranging from about atmospheric pressure to about 30 atmospheres, a weight hourly space velocity (WHSV) ranging from about 5 hr⁻¹ to about 70 hr⁻¹ or about 2 hr⁻¹ to about 50 hr⁻¹, and an aromatic hydrocarbon/olefin mole ratio ranging from about 1:1 to about 20:1. In non-limiting examples, the aromatic compounds may be alkylated with propylene to produce one or more isopropyl-substituted aromatic compounds, such as cumene and multi-isopropyl substituted benzenes. In other non-limiting examples, the aromatic compounds may be alkylated with ethylene to produce one or more ethyl-substituted aromatic compounds, such as ethylbenzene and multi-ethyl-substituted benzenes.

Phenol alkylation processes with olefins or alcohols may be promoted by the MWW zeolite nanoparticles. Phenol or substituted phenols (e.g., o, m, or p-cresol) may be suitably alkylated. Illustrative reaction conditions may include a temperature ranging from about 100° C. to about 300° C. or about 200° C. to about 250° C., a pressure ranging from about 10 atmospheres to about 25 atmospheres, and a weight hourly space velocity (WHSV) ranging from about 2 hr⁻¹ to about 20 hr⁻¹ or about 2 hr⁻¹ to about 10 hr¹.

Other types of catalytic reactions in which the zeolite nanoparticles may be suitably used include, for example, light paraffin conversion into olefins and/or aromatic compounds, light olefin conversion into gasoline hydrocarbons, hydrocracking, hydrocracking/dewaxing, ether formation from alcohols and olefins, toluene disproportionation, and the like.

When used for promoting an alkylation reaction, suitable reactor systems in which the zeolite nanoparticles or an extrudate form thereof may be present include, but not limited to, a fixed bed reactor, a moving bed reactor, a fluidized bed reactor, and/or a reactive distillation unit. In addition, the reactor may include a single alkylation reaction zone or multiple alkylation reaction zones therein. Injection of the alkylating agent can be effected at a single point in the alkylation reactor or at multiple points spaced along the alkylation reactor. Lower aromatic hydrocarbons, such as benzene and/or toluene, and the alkylating agent may be premixed before entering the alkylation reactor or be introduced separately.

When used in suitable catalytic processes, the zeolite nanoparticles may optionally further comprise a metal element and/or be passivated with passivating agent or treated with a selectivating agent to promote a desired type or degree of reactivity. In various instances, the zeolite nanoparticles may be converted into a desired form, such as a H⁺ form, and used without further metal atom loading or passivating/selectivating agent modification. Alkylation of aromatic compounds with olefins or other electrophiles, for instance, may make use of the innate acidity within the pores of the framework structure of the zeolite nanoparticles.

### Embodiments Disclosed Herein Include:

A. Compositions comprising zeolite precursor nanoparticles. The compositions comprise: a plurality of zeolite precursor nanoparticles formed from a parent zeolite precursor having an MWW framework and comprising a plurality of stacked layers; wherein the zeolite precursor nanoparticles are about 200 nm or less in size, and adjacent stacked layers in the MWW framework remain substantially uncondensed with one another in the zeolite precursor nanoparticles; and wherein the zeolite precursor nanoparticles contain at most one structure directing agent (SDA).

B. Methods for making MWW zeolite nanoparticles. The methods comprise: providing a parent zeolite precursor having an MWW framework comprising a plurality of stacked layers; and contacting the parent zeolite precursor with an aqueous base under temperature conditions sufficient to fragment the parent zeolite precursor into a plurality of zeolite precursor nanoparticles that are about 200 nm or less in size and maintain the MWW framework substantially without inducing condensation between adjacent stacked layers in the MWW framework.

C. Aromatic alkylation methods. The methods comprise: providing an aromatic feed mixture comprising one or more C6+ aromatic hydrocarbons; providing an extrudate comprising the composition of A in a calcined form, the calcined form comprising zeolite nanoparticles lacking the structure directing agent; contacting the aromatic feed mixture with the extrudate under alkylation conditions in the presence of an alkylation agent; and obtaining a product stream comprising one or more alkylated C6+ aromatic hydrocarbons after contacting the aromatic feed mixture with the composition under the alkylation conditions.

Embodiments A-C may have one or more of the following additional elements in any combination:

Element 1: wherein the zeolite precursor nanoparticles are about 50 nm to about 250 nm in size.

Element 2A: wherein the zeolite precursor nanoparticles comprise a MCM-22 precursor.

Element 2B: wherein the zeolite precursor nanoparticles comprise an EMM-10 precursor.

Element 2C: wherein the zeolite precursor nanoparticles comprise a MCM-56 precursor, an ITQ-1 precursor, or a UZM-8 precursor.

Element 3: wherein the plurality of zeolite precursor nanoparticles are grouped together as a plurality of agglomerates.

Element 4: wherein the aqueous base comprises an alkali metal hydroxide.

Element 5: wherein the method further comprises calcining the plurality of zeolite precursor nanoparticles in air to form a plurality of zeolite nanoparticles.

Element 6: wherein the method further comprises combining the plurality of zeolite nanoparticles with a binder; and forming an extrudate comprising the plurality of zeolite nanoparticles mixed with the binder.

Element 7A: wherein the temperature conditions comprise a temperature ranging from a freezing point of the aqueous base to about 60° C.

Element 7B: wherein the temperature conditions comprise a temperature ranging from a freezing point of the aqueous base to about 40° C.

Element 8: wherein contacting comprises stirring the parent zeolite precursor with the aqueous base.

Element 9: wherein the parent zeolite precursor contains a structure directing agent.

Element 10: wherein the zeolite nanoparticles in the extrudate are at least as active as a MWW parent zeolite toward promoting alkylation of the one or more C6+ aromatic hydrocarbons.

Element 11: wherein the C6+ aromatic hydrocarbons consist essentially of benzene.

Element 12: wherein alkylation agent comprises propylene, and the product stream comprises one or more isopropyl-functionalized C6+ aromatic hydrocarbons.

Element 13: wherein at least a majority of the product stream comprises isopropyl-functionalized C6+ aromatic hydrocarbons bearing one isopropyl group.

Element 14: wherein the zeolite nanoparticles in the extrudate form the isopropyl-functionalized C6+ aromatic hydrocarbons bearing one isopropyl group at a higher selectivity than does an unbound form of the zeolite nanoparticles.

By way of non-limiting example, exemplary combinations applicable to A-C include, but are not limited to: 1, and 2A, 2B or 2C; 1 and 3; and 2A, 2B or 2C, and 3. Non-limiting combinations applicable to B include any of the foregoing applicable to A-C in further combination with one or more than one of 4-9. Additional non-limiting combinations applicable to B include, but are not limited to, 4 and 5; 4 and 6; 4, and 7A or 7B; 4 and 8; 4 and 9; 5 and 6; 5, and 7A or 7B; 5 and 8; 5 and 9; 6, and 7A or 7B; 6 and 8; 6 and 9; 7A or 7B, and 8; 7A or 7B, and 9; and 8 and 9. Non-limiting combinations applicable to C include any of the foregoing applicable to A-C in further combination with one or more of 10-14. Additional non-limiting combinations applicable to C include, but are not limited to, 10 and 11, 10 and 12, 10-12; 10 and 13; 10 and 14; 10-13; 10-12 and 14; 11 and 12; 11-13; 11 and 14; 12 and 13; 12 and 14; and 13 and 14.

The present disclosure further relates to the following non-limiting embodiments:

A1. A composition comprising:
a plurality of zeolite precursor nanoparticles formed from a parent zeolite precursor having an MWW framework and comprising a plurality of stacked layers;
wherein the zeolite precursor nanoparticles are about 200 nm or less in size, and adjacent stacked layers in the MWW framework remain substantially uncondensed with one another in the zeolite precursor nanoparticles; and
wherein the zeolite precursor nanoparticles contain at most one structure directing agent (SDA).

A2. The composition of A1, wherein the zeolite precursor nanoparticles are about 50 nm to about 250 nm in size.

A3. The composition of A1 or A2, wherein the zeolite precursor nanoparticles comprise a MCM-22 precursor.

A4. The composition of A1 or A2, wherein the zeolite precursor nanoparticles comprise an EMM-10 precursor.

A5. The composition of A1 or A2, wherein the zeolite precursor nanoparticles comprise a MCM-56 precursor, an ITQ-1 precursor, or a UZM-8 precursor.

A6. The composition of any one of A1-A5, wherein the plurality of zeolite precursor nanoparticles are grouped together as a plurality of agglomerates.

B1. A method comprising:
providing a parent zeolite precursor having an MWW framework comprising a plurality of stacked layers; and
contacting the parent zeolite precursor with an aqueous base under temperature conditions sufficient to fragment the parent zeolite precursor into a plurality of zeolite precursor nanoparticles that are about 200 nm or less in size and maintain the MWW framework substantially without inducing condensation between adjacent stacked layers in the MWW framework.

B2. The method of B1, wherein the aqueous base comprises an alkali metal hydroxide.

B3. The method of B1 or B2, further comprising:
calcining the plurality of zeolite precursor nanoparticles in air to form a plurality of zeolite nanoparticles.

B4. The method of B3, further comprising:
combining the plurality of zeolite nanoparticles with a binder; and
forming an extrudate comprising the plurality of zeolite nanoparticles mixed with the binder.

B5. The method of any one of B1-B4, wherein the temperature conditions comprise a temperature ranging from a freezing point of the aqueous base to about 60° C.

B6. The method of any one of B1-B4, wherein the temperature conditions comprise a temperature ranging from a freezing point of the aqueous base to about 40° C.

B7. The method of any one of B1-B6, wherein contacting comprises stirring the parent zeolite precursor with the aqueous base.

B8. The method of any one of B1-B7, wherein the zeolite precursor nanoparticles range from about 50 nm to about 250 nm in size.

B9. The method of any one of B1-B8, wherein the parent zeolite precursor comprises a MCM-22 precursor.

B10. The method of any one of B1-B8, wherein the parent zeolite precursor comprises an EMM-10 precursor.

B11. The method of any one of B1-B8, wherein the parent zeolite precursor comprises an MCM-56 precursor, an ITQ-1 precursor, or a UZM-8 precursor.

B12. The method of any one of B1-B11, wherein the plurality of zeolite precursor nanoparticles are grouped together as a plurality of agglomerates.

B13. The method of any one of B1-B12, wherein the parent zeolite precursor contains a structure directing agent.

C1. An aromatic alkylation method, comprising
providing an aromatic feed mixture comprising one or more C6+ aromatic hydrocarbons;
providing an extrudate comprising the composition of any one of A1-A6 in a calcined form, the calcined form comprising zeolite nanoparticles lacking the structure directing agent;
contacting the aromatic feed mixture with the extrudate under alkylation conditions in the presence of an alkylation agent; and
obtaining a product stream comprising one or more alkylated C6+ aromatic hydrocarbons after contacting the aromatic feed mixture with the composition under the alkylation conditions.

C2. The aromatic alkylation method of C1, wherein the zeolite nanoparticles in the extrudate are at least as active as a MWW parent zeolite toward promoting alkylation of the one or more C6+ aromatic hydrocarbons.

C3. The aromatic alkylation method of C1 or C2, wherein the C6+ aromatic hydrocarbons consist essentially of benzene.

C4. The aromatic alkylation method of any one of C1-C3, wherein alkylation agent comprises propylene, and the product stream comprises one or more isopropyl-functionalized C6+ aromatic hydrocarbons.

C5. The aromatic alkylation method of any one of C1-C4, wherein at least a majority of the product stream comprises isopropyl-functionalized C6+ aromatic hydrocarbons bearing one isopropyl group.

C6. The aromatic alkylation method of C5, wherein the zeolite nanoparticles in the extrudate form the isopropyl-functionalized C6+ aromatic hydrocarbons bearing one isopropyl group at a higher selectivity than does an unbound form of the zeolite nanoparticles.

To facilitate a better understanding of the embodiments of the present disclosure, the following examples of preferred or representative embodiments are given. In no way should the following examples be read to limit, or to define, the scope of the invention.

### EXAMPLES

### Example 1: General Procedure for Production of Zeolite Nanoparticles from MCM-22 Zeolite Precursor

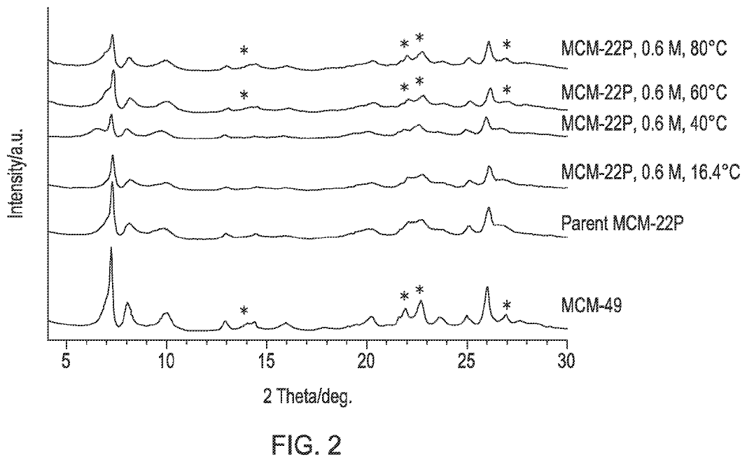

An aqueous NaOH solution was introduced to a polytetrafluoroethylene container, and heated under magnetic stirring conditions to a designated temperature in an oil bath (concentrations and temperatures for various runs specified in FIG. 2). The temperature of the solution was measured using a thermocouple probe. After reaching the designated temperature, MCM-22 zeolite precursor (MCM-22P) powder was added, and the suspension was stirred for 2 hours. MCM-22P is an MWW zeolite having an uncondensed ordered layer structure. The NaOH solution:zeolite precursor powder volume:mass ratio was fixed at 10 mL:1 g. The container was capped with aluminum foil to prevent evaporation. After 2 hours, the product for each run was collected either by filtration or centrifugation. The zeolite precursor nanoparticles were further characterized by powder X-ray diffraction (see below) prior to calcination. The zeolite precursor nanoparticles were dried for 6 hours or more at 120° C. and then calcined in air at for 6 hours at 550° C. The calcined zeolite nanoparticles were then ion-exchanged three times with 1 M NH₄NO₃ solution for 1 hour each time. The ion-exchanged product was dried for 6 hours or more at 120° C. and again calcined in air at for 6 hours at 550° C. For cumene alkylation testing (Example 3 below), the ion-exchanged product was further sized to 14/25 mesh size to maintain a constant particle size between runs.

The zeolite precursor nanoparticles prepared under various alkaline treatment conditions were analyzed by powder X-ray diffraction. FIG. 2 shows a diagram of overlaid powder X-ray diffraction patterns for MCM-22 zeolite precursor nanoparticles produced according to Example 1 under various conditions. MCM-49 (bottom XRD pattern) is provided as an example of a MWW zeolite having a fully condensed layer structure. As shown, peaks characteristic of a MWW zeolite having a fully condensed layer structure (corresponding to the peak positions in MCM-49) began to appear at a treatment temperature of 60° C. or greater. At 40° C. and below, in contrast, the XRD peaks substantially overlaid those of the MCM-22 parent zeolite precursor, indicating that no significant formation of a fully condensed layer structure occurred when forming zeolite precursor nanoparticles at the lower treatment temperatures. Without being bound by theory or mechanism, it is believed that at higher treatment temperatures, significant dissolution of framework silicate may occur, thereby leading to interlayer condensation and corresponding yield loss.

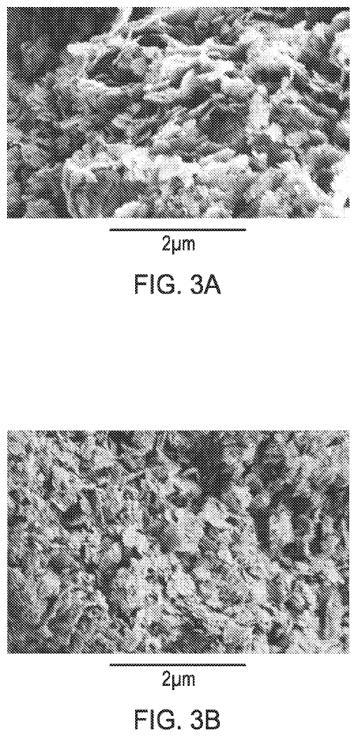

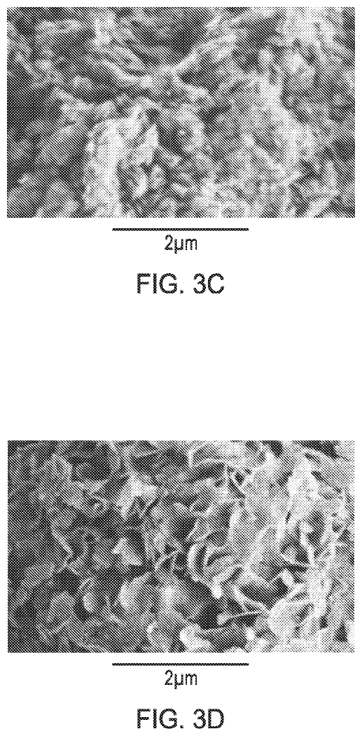

The zeolite precursor nanoparticles were also characterized by scanning electron microscopy (SEM) imaging. FIGS. 3A-3C show SEM images of MCM-22 zeolite precursor nanoparticles produced according to Example 1 under various conditions. FIG. 3D shows an SEM image of parent MCM-22 zeolite precursor. As shown in FIG. 3D, the parent MCM-22 zeolite precursor was in a nanosheet morphology having particle sizes in the 400-500 nm range. FIG. 3A shows the zeolite precursor nanoparticles of Example 1 produced at 80° C., conditions which promote at least partial interlayer condensation and are similar to those used in conventional processes for forming MWW zeolite nanoparticles under alkaline fragmentation conditions. The zeolite precursor nanoparticles were about 100-200 nm in size, with the zeolite precursor nanoparticles being agglomerated together with one another. FIGS. 3B and 3C show the zeolite precursor nanoparticles of Example 1 produced at 16.4° C. and 40° C., respectively. As shown, the particle sizes were comparable to those obtained at 80° C. (FIG. 3A) and with a similar extent of nanoparticle agglomeration, but without significant interlayer condensation occurring (FIG. 2).

### Example 2: General Procedure for Production of Zeolite Precursor Nanoparticles from EMM-10

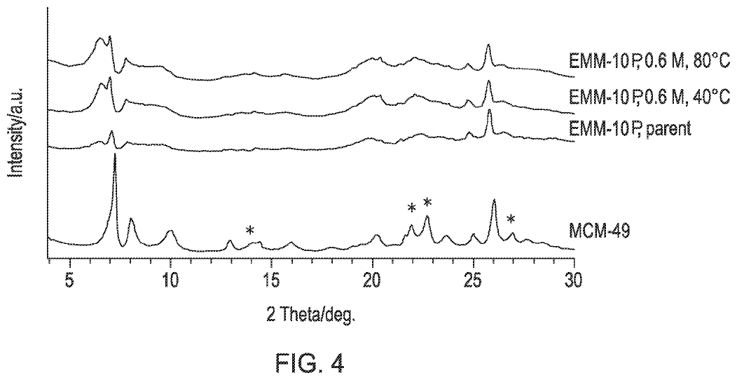

The procedure of Example 1 was followed, except substituting an equivalent amount of EMM-10 zeolite precursor powder for MCM-22 zeolite precursor powder. EMM-10 is a MWW zeolite having multi-layered disordered stacking. Concentrations and temperatures for various runs are specified in FIG. 4.

EMM-10 zeolite precursor nanoparticles prepared under various alkaline treatment conditions were analyzed by powder X-ray diffraction. FIG. 4 shows a diagram of overlaid powder X-ray diffraction patterns for EMM-10 zeolite precursor nanoparticles produced according to Example 2 under various conditions. MCM-49 (bottom XRD pattern) is provided as an example of a MWW zeolite having a fully condensed layer structure. As shown, the XRD peaks substantially overlaid those of the EMM-10 parent zeolite precursor, indicating that no significant formation of a condensed layer structure occurred upon forming zeolite precursor nanoparticles, even at a treatment temperature of 80° C. Also the peak at 20=6.5° was still present following treatment at 80° C., which is different from the behavior observed when processing MCM-22 precursor under similar conditions (Example 1). The broadened peak at 20=8-10 was also well preserved under these alkaline treatment conditions.

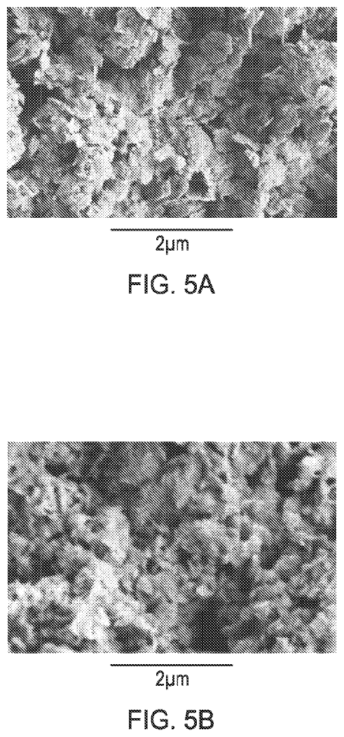

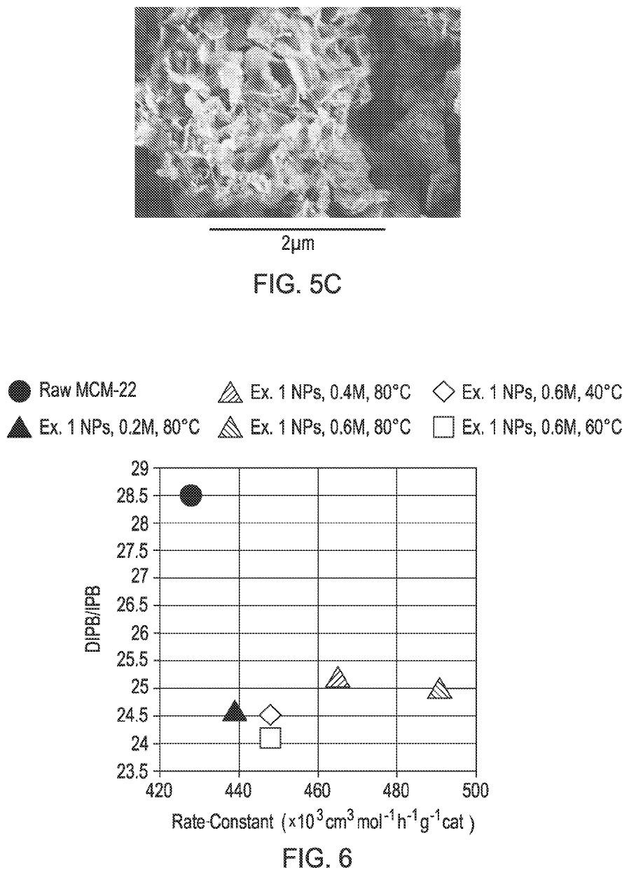

The zeolite precursor nanoparticles were also characterized by SEM imaging. FIGS. 5A and 5B show SEM images of EMM-10 zeolite precursor nanoparticles produced according to Example 2 under various conditions. FIG. 5C shows an SEM image of parent EMM-10 zeolite precursor. As shown in FIG. 5C, the parent EMM-10 zeolite precursor exhibited an aggregated nanosheet morphology having particle sizes in the 300-500 nm range. FIG. 5A shows the zeolite precursor nanoparticles of Example 2 produced at 80° C., and FIG. 5B shows the zeolite precursor nanoparticles of Example 2 produced at 40° C. Unlike MCM-22, the product morphology of the zeolite precursor nanoparticles appeared to be similar under both sets of reaction conditions, each of which afforded zeolite precursor nanoparticles in about a 100-200 nm size range, with the zeolite precursor nanoparticles being further agglomerated together. A lower yield of zeolite precursor nanoparticles (˜40%) was obtained at a reaction temperature of 80° C. compared to that obtained at 40° C. (˜80%).

### Example 3: Benzene Alkylation to Produce Cumene (Cumene Alkylation)

Unbound Zeolite Nanoparticles: MCM-22 zeolite nanoparticles were prepared under a range of conditions (see FIG. 6) similar to those of Example 1 and were exposed to benzene in unbound form after sizing to a 14/25 mesh size. Propylene gas was used as the alkylating agent. The second-order kinetic parameter of cumene alkylation (Rate-Constant) and amounts of isopropylbenzene [IPB](cumene) and diisopropylbenzene [DIPB] were determined. The Rate-Constant was calculated using methods known to those skilled in the art. See “Principles and Practice of Heterogeneous Catalyst”, J. M. Thomas, W. J. Thomas. VCH, 1st Edition, 1997, the disclosure of which is incorporated herein by reference. Briefly, a mixture of benzene/propylene (3:1 mol/mol) was contacted with 0.5 g of catalyst at 130° C. and 300 psig in a stirred, batch autoclave. Small aliquots of liquid were removed from the autoclave every thirty minutes for three hours and analyzed offline via gas chromatography. Rate-Constant values, corresponding to the pseudosecond-order rate constant for the consumption of propylene (×10³ cm³ mol⁻¹ h⁻¹ g⁻¹ cat), were used to compare the activity between runs, whereas the diisopropylbenzene/isopropylbenzene (DIPB/IPB) weight ratio was used to compare the selectivity of the catalysts toward cumene production, the desired product.

FIG. 6 is a plot of the ratio [DIPB]/[IPB] versus the kinetic parameter of cumene alkylation (Rate-Constant) using MCM-22 zeolite nanoparticles. Preferred zeolite catalysts exhibit both a high Rate-Constant and a low [DIPB]/[IPB] ratio (i.e., toward the lower right-hand side of the plot). Referring to FIG. 6, the parent MCM-22 zeolite afforded poor [DIPB]/[IPB] selectivity and a low Rate-Constant. The zeolite nanoparticles, in contrast, afforded considerably higher [DIPB]/[IPB] selectivity values, all of which ranged between about 24-25.5. Zeolite nanoparticles produced at 80° C., conditions leading to at least partial formation of a condensed phase, afforded slightly poorer (higher) [DIPB]/[IPB] ratios than did the zeolite nanoparticles produced at 40° C. or 60° C. For the three zeolite nanoparticle samples produced at 80° C., the Rate-Constant increased with increasing base concentration used to form the zeolite nanoparticles, possibly due to the more rigorous reaction conditions and the extent of fragmentation and desilation resulting therefrom Although the Rate-Constant was slightly lower for the zeolite nanoparticles formed at lower temperatures (40° C. and 60° C.) than for two of the three samples formed at 80° C., the [DIPB]/[IPB] ratios for the low-temperature samples were more favorable.

Zeolite Nanoparticle Extrudates. Extrudates were formed by combining parent MCM-22 zeolite or MCM-22 zeolite nanoparticles with V300 alumina in a muller and forming extrudates by extruding the resulting blend through a 1/20″ quadralobe die. Further details regarding the extrusion process may be found in U.S. Patent Application Publication 2008/0045765, incorporated herein by reference. The extrudates were subjected to ammonium exchange followed by calcination in air at 540° C. The calcined extrudates contacted with benzene under alkylation conditions to form cumene in a manner similar to that described above. The catalytic reaction data is presented in Table 1 below, along with comparative date for parent MCM-22 and MCM-49 extrudates (DIPB=diisopropylbenzene, TIPB=triisopropylbenzene).

TABLE 1

| | | | Cumene | | |
|---|---|---|---|---|---|
| | | | Activity | | |
| | | | (×10³ cm³ | DIPB/IPB | TIPB/IPB |
| | Sample | | mol⁻¹h⁻¹ | Selectivity | Selectivity |
| Entry | # | Composition | g⁻¹ cat) | (%) | (%) |
| 1 | 1 | MCM-22 NPs | 362 | 18.4 | 2.18 |
| | (Exp.) | (40° C.):alumina | | | |
| | | (80/20 w/w) | | | |
| 2 | 2 | MCM-22 NPS | 501 | 16 | 2.23 |
| | (Comp.) | (80° C.):alumina | | | |
| | | (80:20 w/w) | | | |
| 3 | 3 | MCM-22 NPs | 326 | 14.8 | 1.42 |
| | (Comp.) | (80° C.):alumina | | | |
| | | (40:60 w/w) | | | |
| 4 | 4 | Parent MCM-22 | 256 | 15 | 1.7 |
| | (Control) | zeolite:alumina | | | |
| | | (40:60 w/w) | | | |
| 5 | 5 | Parent MCM- | 260 | 19 | 2.42 |
| | (Control) | 49:alumina | | | |

As shown, the MCM-22 zeolite nanoparticles afforded comparable results to one another. All of the zeolite nanoparticle samples (Entries 1-3) exhibited higher cumene alkylation activity values than did the MCM-22 parent zeolite. The cumene alkylation activity values were enhanced compared to the unbound zeolite nanoparticles (comparing Entries 3 and 4 in Table 2 against Example 1 nanoparticles/0.6 M/60′C and raw MCM-22 in FIG. 6). Moreover, by tailoring the amount of zeolite nanoparticles in the extrudates, the selectivity toward isopropylbenzene formation could be made more specific. When present at similar loading percentages within the extrudates, the selectivity for isopropylbenzene was higher for the zeolite nanoparticles (comparing Entries 3 and 4).

Many alterations, modifications, and variations will be apparent to one having ordinary skill in the art in light of the foregoing description without departing from the spirit or scope of the present disclosure and that when numerical limits and numerical upper limits are listed herein, ranges from any lower limit to any upper limit are contemplated.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising.” it is understood that we also contemplate the same composition or group of elements with transitional phrases “consisting essentially of,” “consisting of,” “selected from the group of consisting of,” or “is” preceding the recitation of the composition, element, or elements and vice versa.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed, including the lower limit and upper limit. In particular, every range of values (of the form. “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A composition comprising:
a plurality of zeolite precursor nanoparticles formed from a parent zeolite precursor having an MWW framework and comprising a plurality of stacked layers;
wherein the zeolite precursor nanoparticles are about 200 nm or less in size, and adjacent stacked layers in the MWW framework remain substantially uncondensed with one another in the zeolite precursor nanoparticles; and
wherein the zeolite precursor nanoparticles contain at most one structure directing agent (SDA).

2. The composition of claim 1, wherein the zeolite precursor nanoparticles are about 50 nm to about 250 nm in size.

3. The composition of claim 1, wherein the zeolite precursor nanoparticles comprise a MCM-22 precursor.

4. The composition of claim 1, wherein the zeolite precursor nanoparticles comprise an EMM-10 precursor.

5. The composition of claim 1, wherein the zeolite precursor nanoparticles comprise a MCM-56 precursor, an ITQ-1 precursor, or a UZM-8 precursor.

6. The composition of claim 1, wherein the plurality of zeolite precursor nanoparticles are grouped together as a plurality of agglomerates.

7. A method comprising:
providing a parent zeolite precursor having an MWW framework comprising a plurality of stacked layers; and
contacting the parent zeolite precursor with an aqueous base under temperature conditions sufficient to fragment the parent zeolite precursor into a plurality of zeolite precursor nanoparticles that are about 200 nm or less in size and maintain the MWW framework substantially without inducing condensation between adjacent stacked layers in the MWW framework.

8. The method of claim 7, wherein the aqueous base comprises an alkali metal hydroxide.

9. The method of claim 7, further comprising:
calcining the plurality of zeolite precursor nanoparticles in air to form a plurality of zeolite nanoparticles.

10. The method of claim 7, further comprising:
combining the plurality of zeolite nanoparticles with a binder; and
forming an extrudate comprising the plurality of zeolite nanoparticles mixed with the binder.

11. The method of claim 7, wherein the temperature conditions comprise a temperature ranging from a freezing point of the aqueous base to about 60° C.

12. The method of claim 11, wherein the temperature conditions comprise a temperature ranging from a freezing point of the aqueous base to about 40° C.

13. The method of claim 7, wherein contacting comprises stirring the parent zeolite precursor with the aqueous base.

14. The method of claim 7, wherein the zeolite precursor nanoparticles are about 50 nm to about 250 nm in size.

15. The method of claim 7, wherein the parent zeolite precursor comprises a MCM-22 precursor.

16. The method of claim 7, wherein the parent zeolite precursor comprises an EMM-10 precursor.

17. The method of claim 7, wherein the parent zeolite precursor comprises an MCM-56 precursor, an ITQ-1 precursor, or a UZM-8 precursor.

18. The method of claim 7, wherein the plurality of zeolite precursor nanoparticles are grouped together as a plurality of agglomerates.

19. The method of claim 7, wherein the parent zeolite precursor contains a structure directing agent.

20. An aromatic alkylation method, comprising:
providing an aromatic feed mixture comprising one or more C6+ aromatic hydrocarbons;
providing an extrudate comprising the composition of claim 1 in a calcined form, the calcined form comprising zeolite nanoparticles lacking the structure directing agent;
contacting the aromatic feed mixture with the extrudate under alkylation conditions in the presence of an alkylation agent; and
obtaining a product stream comprising one or more alkylated C6+ aromatic hydrocarbons after contacting the aromatic feed mixture with the composition under the alkylation conditions.

21. The aromatic alkylation method of claim 20, wherein the zeolite nanoparticles in the extrudate are at least as active as a MWW parent zeolite toward promoting alkylation of the one or more C6+ aromatic hydrocarbons.

22. The aromatic alkylation method of claim 21, wherein the C6+ aromatic hydrocarbons consist essentially of benzene.

23. The aromatic alkylation method of claim 20, wherein alkylation agent comprises propylene, and the product stream comprises one or more isopropyl-functionalized C6+ aromatic hydrocarbons.

24. The aromatic alkylation method of claim 20, wherein at least a majority of the product stream comprises isopropyl-functionalized C6+ aromatic hydrocarbons bearing one isopropyl group.

25. The aromatic alkylation method of claim 24, wherein the zeolite nanoparticles in the extrudate form the isopropyl-functionalized C6+ aromatic hydrocarbons bearing one isopropyl group at a higher selectivity than does an unbound form of the zeolite nanoparticles.
